(19) United States
(12) Patent Application Publication
(10) Pub. No.: US 2026/0350981 A1
(43) Pub. Date: Nov. 5, 2026

(54) AUTOMATED BOREHOLE IMAGE QUALITY ZONATION USING DEEP LEARNING

(71) Applicant: Schlumberger Technology Corporation, Sugar Land, TX (US)

(72) Inventors: Olzhas Berkimbay, Doha (QA); Mohamed Hany Nassar, Doha (QA); Rasesh Saraiya, Doha (QA)

(21) Appl. No.: 19/197,035

(22) Filed: May 2, 2025

(51) Int. Cl. G06V 10/98; E21B 7/06; E21B 47/002; G06V 10/764; G06V 10/774; G06V 10/82

(52) U.S. Cl. CPC G06V 10/993; E21B 7/06; E21B 47/002; G06V 10/764; G06V 10/774; G06V 10/82

(57) ABSTRACT

The present disclosure relates to systems and methods that automate borehole image quality assessment using a pre-trained machine learning model. The systems and methods use the machine learning model in classifying the borehole images into categories based on a predicted quality classification by the machine learning model. The systems and methods provide the borehole images with the predicted quality classification for presentation on a display.

### BACKGROUND

Borehole image quality zonation is a crucial step in the overall borehole image interpretation workflow for fracture identification. Manual borehole image quality zonation is labor-intensive and subjective, leading to inconsistencies in fracture identification and analysis. Manual borehole image quality zonation requires significant manual effort from experts, which is time consuming and prone to human error and subjectivity, especially in distinguishing between quality classes in the images, such as “fair” and “good.”

### BRIEF SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Some implementations relate to a method. The method includes receiving an image log with image data for a borehole. The method includes providing, using a machine learning model, a predicted quality classification for an image in the image data at a measured depth within the borehole. The method includes generating a quality zone log for the image data with the predicted quality classification for the image at the measured depth. The method includes providing the quality zone log for presentation on a display.

Some implementations relate to a device. The device includes a processor; memory in electronic communication with the processor; and instructions stored in the memory, the instructions being executable by the processor to: receive an image log with image data for a borehole; provide, using a machine learning model, a predicted quality classification for an image in the image data at a measured depth within the borehole; generate a quality zone log for the image data with the predicted quality classification for the image at the measured depth; and provide the quality zone log for presentation on a display.

Some implementations relate to a computer-readable storage medium including instructions that, when executed by a processor, cause the processor to: receive an image log with image data for a borehole; provide, using a machine learning model, a predicted quality classification for an image in the image data at a measured depth within the borehole; generate a quality zone log for the image data with the predicted quality classification for the image at the measured depth; and provide the quality zone log for presentation on a display.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example environment for image quality classification in accordance with implementations of the present disclosure.

FIG. 2 illustrates an example machine learning model training workflow in accordance with implementations of the present disclosure.

FIG. 3 illustrates an example interpreted image log used in training a machine learning model in accordance with implementations of the present disclosure.

FIG. 4 illustrates examples of quality zone logs in accordance with implementations of the present disclosure.

FIG. 5 illustrates examples of images with a classification in accordance with implementations of the present disclosure.

FIG. 6 illustrates an example method for image quality prediction in accordance with implementations of the present disclosure.

FIG. 7 illustrates components that may be included within a computer system in accordance with implementations of the present disclosure.

### DETAILED DESCRIPTION

This disclosure generally relates to borehole image analysis. Borehole image quality zonation is a crucial step in the overall borehole image interpretation workflow for fracture identification. Borehole image quality zonation enables the exclusion of depth intervals that are not sufficiently reliable for further analysis.

Existing solutions rely on manual interpretation of the borehole images, which is time-consuming and subjective, especially in distinguishing between quality classes, such as “fair” and “good.” Typically, manual interpretation of the borehole images requires substantial manual effort and is prone to the subjectivity of the interpreter and human error, leading to inconsistencies in fracture identification and analysis.

The present disclosure includes methods and systems that automate borehole image quality assessment using a pre-trained machine learning model. In some implementations, the machine learning model is a deep learning model that uses neural networks as an algorithm. For example, the deep learning model uses a convolutional neural network (CNN). The systems and methods leverage transfer learning domain knowledge in classifying the borehole images into categories. Example categories include “poor,” “fair,” and “good.” The methods and systems label the borehole images with a quality label automatically determined by the machine learning model. The methods and systems provide the borehole images with the quality label for presentation on a display.

The present disclosure includes a number of practical applications that provide benefits and/or solve problems associated with borehole image analysis. Examples of these applications and benefits are discussed in further detail below. One example benefit of the systems and methods is enabling quicker quality assessments of a borehole image. Another example benefit of the systems and methods is consistent and reliable quality assessments of a borehole image. Another example benefit of the systems and methods is minimizing human error in quality assessments of a borehole image. Another example benefit of the systems and methods is reducing operating costs. Another example benefit of the systems and methods is improving decision making in subsurface exploration and development.

In some implementations, the machine learning model is a pre-trained deep learning model that uses a CNN that is specially designed for efficient image classification tasks. For example, the pre-trained deep learning model is fine-tuned with geological images for training data and is flexible enough for use in multiclass classification tasks without the significant cost of retraining. In some implementations, the deep learning model uses a structured approach to training, validation, and addressing class imbalance, providing reliable and reproducible classification results. The systems and methods integrate deep learning techniques with domain expertise ensuring consistent and high-quality predictions by the machine learning model.

One technical advantage of the systems and methods of the present disclosure is improving processing time of image quality zonation. The systems and methods automatically classify the image quality into categories. For example, the processing time of an image is reduced to seconds using the systems and methods.

Another technical advantage of the systems and methods is improved accuracy of classifying borehole images. The systems and methods leverage machine learning models and domain specific knowledge in classifying borehole images into quality categories with high accuracy, enhancing the efficiency of fracture identification and overall subsurface analysis. Another technical advantage of the systems and methods of the present disclosure is improved consistency in classifying images. The systems and methods automate borehole image quality zonation while providing accurate and consistent results.

One example use of the systems and methods of the present disclosure is using the image quality zonation in fracture identification in a reservoir. Another example use of the systems and methods of the present disclosure is using the image quality zonation in subsurface exploration. Another example use of the systems and methods of the present disclosure is modifying a drilling trajectory in a reservoir based on fracture identification in images of the reservoir.

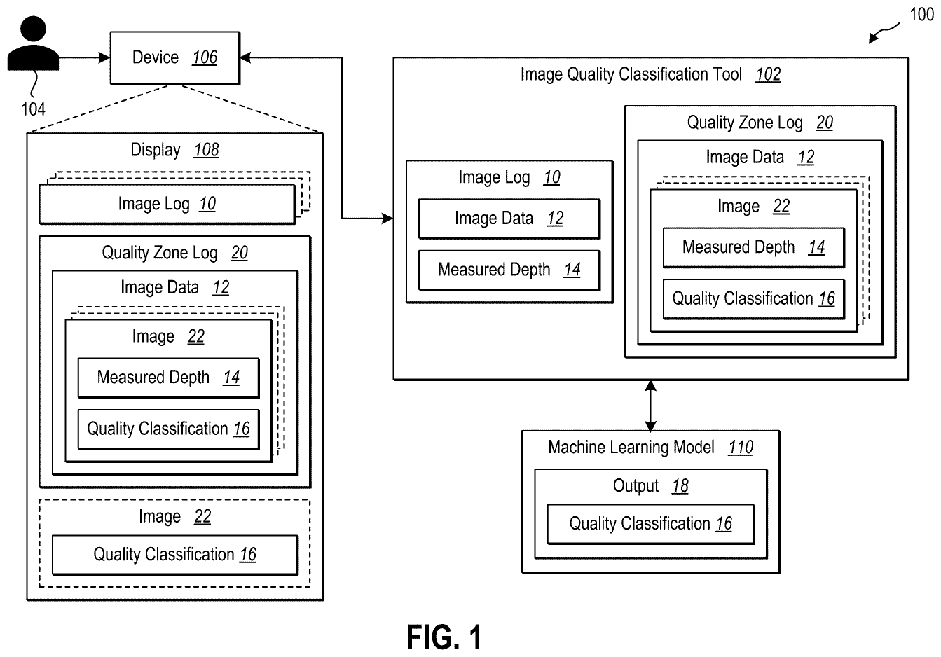

Referring now to FIG. 1, illustrated is an example environment 100 for image quality classification. The environment 100 includes an image quality classification tool 102 that uses a machine learning model 110 in classifying an image log 10 of a borehole. The borehole is the hole drilled into the rock and the rock face that bounds the drilled hole is called the borehole wall. An image log 10 includes image data 12 taken at different measured depths 14 of the borehole. An image log 10 includes high-resolution images acquired along the borehole wall at different measured depths. An image log 10 assist geologists in identifying structural and sedimentological features in a reservoir, such as fractures, bedding planes and lithological variations. In some implementations, the image quality classification tool 102 is an artificial intelligence (AI) assisted platform. One example includes a generative AI assistant that the user 104 accesses to aid in classifying image logs 10.

The user 104 accesses the image quality classification tool 102 using a device 106. In some implementations, the image quality classification tool 102 is local to the device 106 of the user 104. In some implementations, the image quality classification tool 102 is on a cloud server remote from the device 106 accessed through a network. For example, the image quality classification tool 102 is hosted on virtual machines in the cloud. For example, a server address configured to an end point of the image quality classification tool 102 is provided to the device 106 that the user 104 may access using a browser on the device 106 through the network.

The network may include one or multiple networks and may use one or more communication platforms and/or technologies suitable for transmitting data. The network may refer to any data link that enables transport of electronic data between devices of the environment 100. The network may refer to a hardwired network, a wireless network, or a combination of a hardwired network and a wireless network. In one or more implementations, the network includes the internet. The network may be configured to facilitate communication between the various computing devices via well-site information transfer standard markup language (WITSML) or similar protocol, or any other protocol or form of communication. Another example includes an application on the device 106 of the user 104 provides access to the image quality classification tool 102.

A display 108 in communication with the device 106 provides a user interface that the user 104 uses to provide an image log 10 to the image quality classification tool 102. In some implementations, the user 104 provides a plurality of image logs 10 to the image quality classification tool 102. The image quality classification tool 102 uses a machine learning model 110 in analyzing the image data 12 and generating an output 18 with a predicted quality classification 16 for the image data 12. The predicted quality classification 16 provides a rating of image quality. Image quality refers to the overall appearance of the image data 12 based on factors in the image data 12, such as contrast, spatial resolution, and the ability to perceive fine details. Image quality is the measure of interpretability of the image data 12. Image quality can vary based on the tools used to acquire the image data 12. Image quality can also vary based on inconsistencies in the image data. In some implementations, the rating includes three categories: poor, fair, and good. For example, a poor image is not possible to interpret due to artifacts. Another example includes a fair image is possible to interpret but with some uncertainty. Another example includes a good image is fine to interpret. In some implementations, the categories are based on a subjective classification of an interpreter of the image data 12. In some implementations, the rating includes two categories: poor and good. The rating may include any number of categories.

The machine learning model 110 generates an output 18 with the predicted quality classification 16 for the image data 12 based on analyzing the image data 12. In some implementations, the machine learning model 110 is a pre-trained deep learning model that uses a CNN that is specially designed for efficient image classification tasks. In some implementations, the machine learning model 110 is fine-tuned during training for geological images and classifying image quality of geological images. For example, the machine learning model 110 recognizes patterns in the image data 12 based on the training and generates the predicted quality classification 16 for the image data 12 using the patterns. In some implementations, the machine learning model 110 uses a fully trained CNN that determines a macro-average F1-score and compares the average F1-score with a baseline score (e.g., a score for “fair” images) and determines the predicted quality classification 16 based on the comparison of the average F1-score to the baseline score.

The image log 10 is treated as a set of images 22 by the machine learning model 110, where each image 22 is labelled by the machine learning model 110 with a predicted quality classification 16 indicating a quality level of the image 22. In some implementations, the images 22 are a constant size and resolution. In some implementations, the machine learning model 110 analyzes the image data 12 at different measured depths 14 and provides a predicted quality classification 16 for each measured depth 14.

In some implementations, the image log 10 has different predicted quality classifications 16 for different measured depths 14. For example, at a first measured depth 14, a first image 22 in the image log 10 has a predicted quality classification 16 of “good,” at a second measured depth 14, a second image 22 in the image log 10 has a predicted quality classification 16 of “good,” at a third measured depth 14, a third image 22 in the image log 10 has a predicted quality classification 16 of “poor,” and at a fourth measured depth 14, a fourth image 22 in the image log 10 has a predicted quality classification 16 of “fair.”

In some implementations, the image log 10 has the same predicted quality classification 16 for different measured depths 14. For example, at a first measured depth 14, a first image 22 in the image log 10 has a predicted quality classification 16 of “fair,” at a second measured depth 14, a second image 22 in the image log 10 has a predicted quality classification 16 of “fair,” and at a third measured depth 14, a third image 22 in the image log 10 has a predicted quality classification 16 of “fair.”

In some implementations, the image quality classification tool 102 uses a plurality of machine learning models 110 in providing the image predicted quality classification 16. In some implementations, the plurality of machine learning models 110 are custom deep learning models trained on training data to refine image quality classifications.

The image quality classification tool 102 uses the output 18 with the quality classification in creating a quality zone log 20. The quality zone log 20 includes the image data 12 from the image log 10 and for each image 22, the measured depth 14, and the predicted quality classification 16 predicted by the machine learning model 110.

In some implementations, the image quality classification tool 102 sends the quality zone log 20 for presentation on the display 108. For example, the image quality classification tool 102 sends the quality zone log 20 in response to receiving an image log 10. In some implementations, the image quality classification tool 102 sends an image 22 with the predicted quality classification 16 for presentation on the display 108.

In some implementations, the user 104 views the quality zone log 20 and uses the predicted quality classifications 16 in identifying portions of the quality zone log 20 to use in characterizing the reservoir associated with the image data 12. Characterizing the reservoir may include identifying whether a fracture exists in the reservoir. Characterizing the reservoir may also include identifying the lithology of the reservoir. For example, the user 104 ignores the images 22 with a predicted quality classification 16 of “poor” during the reservoir characterization. Another example includes the user 104 uses the images 22 with a predicted quality classification 16 of “good” in characterizing the reservoir. Another example includes the user 104 uses the images 22 with a predicted quality classification 16 of “fair” in characterizing the reservoir.

In some implementations, the user 104 uses the predicted quality classification 16 and the analysis of the images 22 in performing actions related to the reservoir associated with the image data 12. One example action includes the user 104 reimaging the reservoir. For example, if the predicted quality classification 16 is “poor” over a depth in a reservoir where fracture identification is essential, the user 104 may decide to reimage the reservoir. Another example action includes modifying the drilling operations of the reservoir associated with the image data 12. For example, the user 104 changes a direction of drilling towards a fracture identified in the reservoir based on the analysis of the images 22 increasing a flow of hydrocarbons in a borehole at the reservoir. Another example includes the user 104 changes a direction of drilling away from a fracture identified in the reservoir based on the analysis of the images 22 avoiding a fracture of water in the reservoir.

The environment 100 provides consistent quality classifications of image logs allowing users to perform reservoir characterization quicker. The environment 100 enhances the efficiency of fracture identification and subsurface analysis assisting users in making drilling decisions at a reservoir.

In some implementations, one or more computing devices (e.g., servers and/or devices) are used to perform the processing of the environments 100. The one or more computing devices may include, but are not limited to, server devices, cloud virtual machines, personal computers, a mobile device, such as a mobile telephone, a smartphone, a PDA, a tablet, or a laptop, and/or a non-mobile device. The features and functionalities discussed herein in connection with the various systems may be implemented on one computing device or across multiple computing devices. For example, the image quality classification tool 102 and the machine learning model 110 are implemented on a single device. Moreover, in some implementations, one or more subcomponents of the features and functionalities discussed herein may be implemented and are processed on different server devices of the same or different cloud computing networks. For example, the image quality classification tool 102 and the machine learning model 110 are implemented across a plurality of devices.

In some implementations, each of the components of the environment 100 is in communication with each other using any suitable communication technologies. In addition, while the components of the environment 100 are shown to be separate, any of the components or subcomponents may be combined into fewer components, such as into a single component, or divided into more components as may serve a particular implementation. In some implementations, the components of the environment 100 include hardware, software, or both. For example, the components of the environment 100 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 100 include hardware, such as a special purpose processing device to perform a certain function or group of functions. In some implementations, the components of the environment 100 include a combination of computer-executable instructions and hardware.

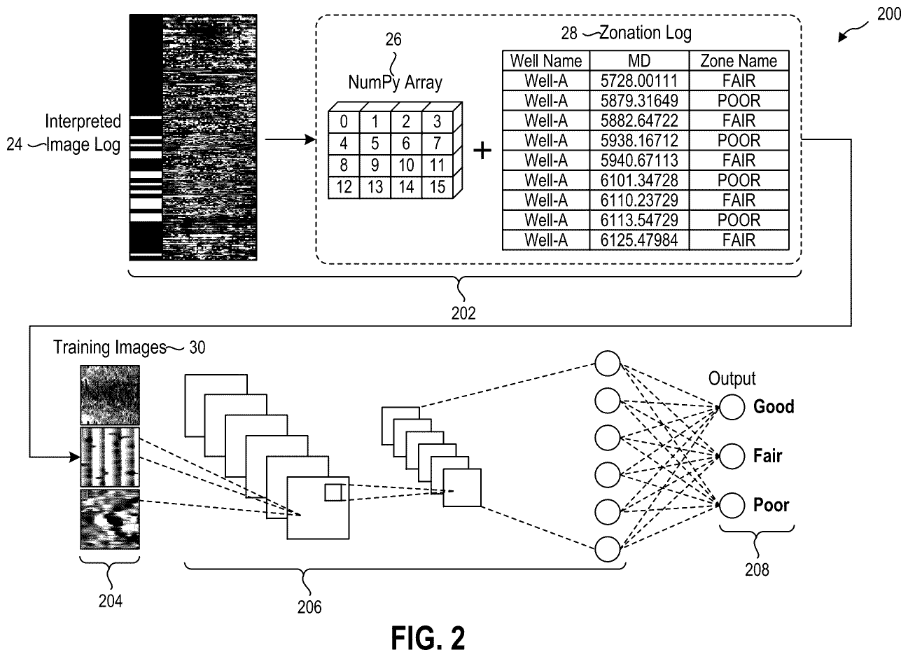

FIG. 2 illustrates an example machine learning model training workflow 200. In some implementations, the machine learning model 110 (FIG. 1) is trained using the machine learning model training workflow 200. For example, the machine learning model 110 is deep learning model that uses a CNN.

At 202, the machine learning model training workflow 200 includes training images preparation. The training images preparation starts with interpreted image logs 24 by applying a quality classification of the image quality of the image logs used for the training data. In some implementations, a user (e.g., a borehole geology specialist) creates the interpreted image logs 24 by manually interpreting the image logs for the training data and labeling the image quality. In some implementations, the interpreted image logs 24 are from different wells with varying lithology. Using training data from a variety of rock types and well environments allows the trained machine learning model 110 to generalize different well environments during the predictions of quality classification 16 (FIG. 1).

The training images preparation includes converting the interpreted image log 24 into an array 26 and a zonation log 28. In some implementations, the array 26 is a NumPy array. In some implementations, the zonation log 28 includes the well name, the measured depth, and the zone name (quality label) provided by the user. The zonation log 28 allows for an extraction of single label images from the interpreted image log 24 for the training images 30. The single label is a quality label provided by the user.

At 204, the machine learning model training workflow 200 includes generating training images 30. The training images 30 are images with a quality label (the quality provided by the user). Having a single quality label with no overlap provides consistency in the training data and helps increase the generalization of the machine learning model.

At 206, the machine learning model training workflow 200 includes training the machine learning model. The labeled training images 30 are extracted and used in training the machine learning model by using the transfer learning approach where the final classification layer is trained for a particular classification task and the other layers are kept frozen to decrease the cost associated with model training. In some implementations, the training includes under sampling classes with “good” and “fair” quality zones compared to “poor” quality zones to prevent class imbalances during the training process.

At 208, the machine learning model training workflow 200 includes outputting a trained machine learning model 110 trained for image classification. The machine learning model 110 is trained to classify images into different categories. One example of different categories is three categories: “poor,” “fair,” and “good.” In some implementations, the machine learning model 110 is a fully trained deep learning model that uses a Convolutional Neural Network (CNN), specifically designed for efficient image classification tasks. The CNN is flexible enough to be used in multiclass classification tasks without the significant cost of retraining.

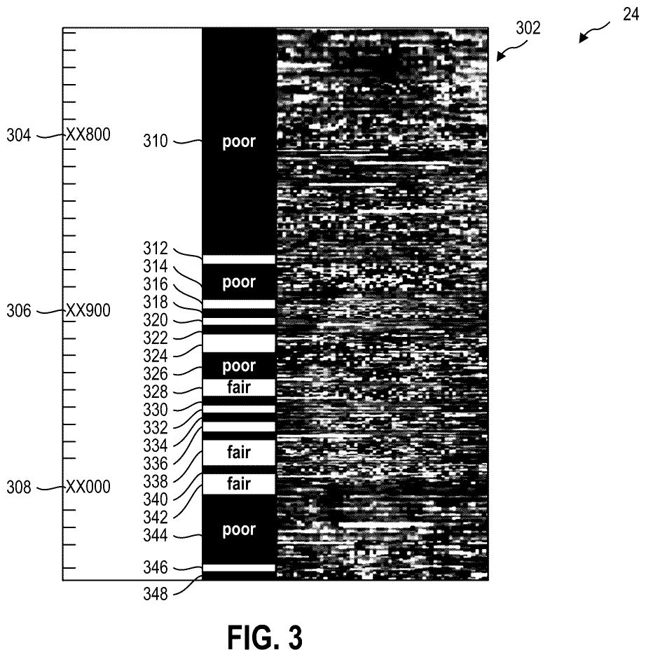

FIG. 3 illustrates an example interpreted image log 24 used in training a machine learning model (e.g., the machine learning model 110 (FIG. 1). In some implementations, the interpreted image log 24 is used in the machine learning model training workflow 200 (FIG. 2). For example, the interpreted image log 24 is for a well selected for training the machine learning model.

The interpreted image log 24 includes an image 302, different measured depths 304, 306, 308 for the well and quality labels 310, 312, 314, 316, 318, 320, 322, 324, 326, 328, 330, 332, 334, 336, 338, 340, 342, 344, 346, 348 for the image 302. In some implementations, a user (e.g., a geologist) provides the quality labels for the image 302 that provides a rating of an overall appearance of the image 302. For example, the quality labels include a “poor” category and a “fair” category. In some implementations, different measured depths include different quality labels. In some implementations, different measured depths include the same quality labels. While a portion of the interpreted image log 24 is illustrated, it should be appreciated that the size of the image 302 may be larger with more measured depths. The quality labels are used to extract training images 30 (FIG. 2) with a quality label used in training the machine learning model 110.

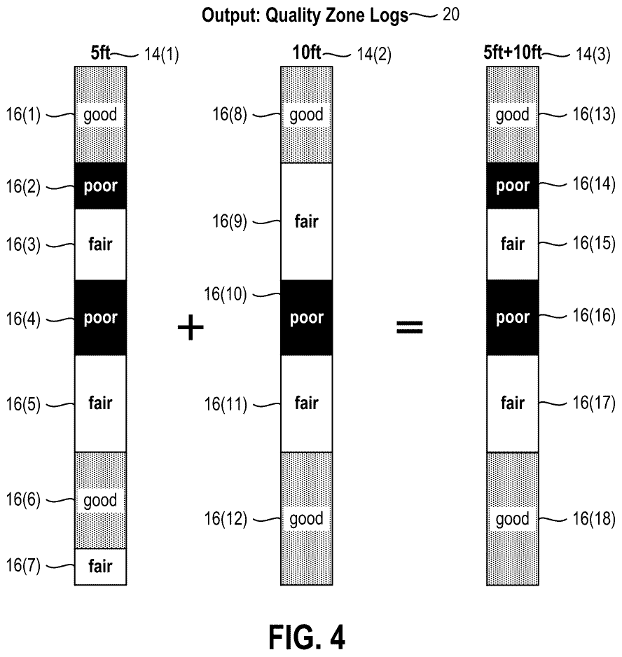

FIG. 4 illustrates an example quality zone log 20 in accordance with implementations of the present disclosure. In some implementations, the image quality classification tool 102 (FIG. 1) provides the quality zone log 20 as output for presentation on a display 108 (FIG. 1). The quality zone log 20 provides the predicted quality classification 16 of the image 22 (FIG. 1) at the measured depth 14. For example, the machine learning model 110 (FIG. 1) generates the predicted quality classifications 16 of the images 22. In the illustrated example, the quality zone log 20 has different measured depths 14(1) (e.g., 5 feet), 14(2) (e.g., 10 feet), 14(3) (a combination of 5 feet and 10 feet).

For example, the measured depth 14(1) has different predicted quality classifications 16(1) “good,” 16(2) “poor,” 16(3) “fair,” 16(4) “poor,” 16(5) “fair,” 16(6) “good,” and 16(7) “fair,” for the image 22. The measured depth 14(2) has different predicted quality classifications 16(8) “good,” 16(9) “fair,” 16(10) “poor,” 16(11) “fair,” and 16(12) “good,” for the image 22. The measured depth 14(3) shows the combination of the different predicted quality classifications from the measured depth 14(1) and 14(2). For example, the combined predicted quality classifications include 16(13) “good,” 16(14) “poor,” 16(15) “fair,” 16(17) “fair,” and 16(18) “good.”

In some implementations, the user 104 (FIG. 1) uses the predicted quality classifications 16 in the quality zone log 20 for determining which portions of the image 22 to analyze further.

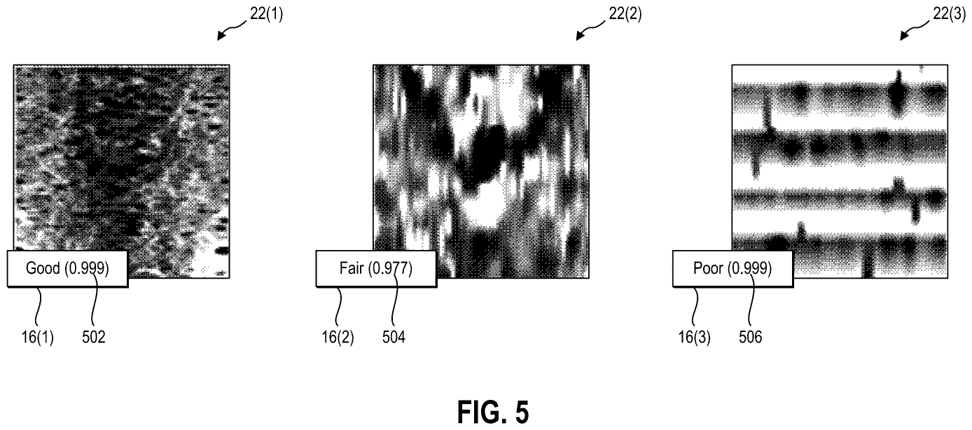

FIG. 5 illustrates an example of images 22(1), 22(2), 22(3) with a predicted quality classification 16(1), 16(2), 16(3). In some implementations, the image quality classification tool 102 provides the images 22(1), 22(2), 22(3) with the predicted quality classification 16(1), 16(2), 16(3) for output on a display 108 (FIG. 1). In some implementations, the machine learning model 110 (FIG. 1) generates the predicted quality classification 16(1), 16(2), 16(3).

In some implementations, the machine learning model 110 generates a probability that the predicted quality classifications 16(1), 16(2), 16(3) are correct where numbers closer to 1 have a higher probability of being correct. For example, the image 22(1) has a quality classification 16(1) of “good” with a probability 502 of 0.999, the image 22(2) has a predicted quality classification 16(2) of “fair” with a probability 504 of 0.977, and the image 22(3) has a predicted quality classification 16(3) of “poor” with a probability 506 of 0.999.

The images 22(1), 22(2), 22(3) with the predicted quality classification 16(1), 16(2), 16(3) aid the user 104 in characterizing the reservoir and making drilling decisions for the well. In some implementations, the user 104 (FIG. 1) uses the images 22(1), 22(2), 22(3) and the predicted quality classifications 16(1), 16(2), 16(3) in characterizing the reservoir. For example, the user 104 analyzes the image 22(1) with a predicted quality classification 16(1) of “good” and the image 22(2) with predicted quality classification 16(2) of “fair” for fractures in the reservoir at the measured depth 14 (FIG. 1) of the images 22(1) and 22(2). The user 104 may skip analyzing the image 22(3) with a predicted quality classification 16(3) of “poor.” The machine learning model 110 classifies the images into quality categories 22(1), 22(2), 22(3) with high accuracy (e.g., the probabilities 502, 504, 506 are near 1) enhancing the efficiency of fracture identification and overall subsurface analysis.

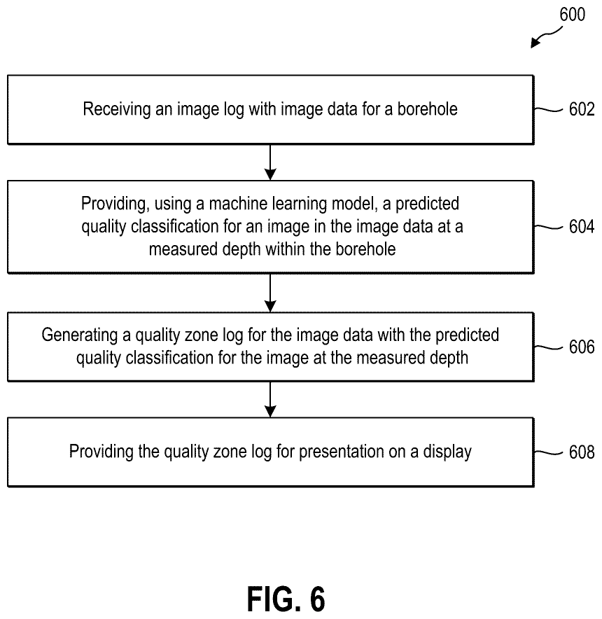

FIG. 6 illustrates an example method 600 for image quality prediction. In some implementations, the image quality classification tool 102 (FIG. 1) performs the method 600.

At 602, the method 600 includes receiving an image log with image data for a borehole. In some implementations, the image quality classification tool 102 receives the image log 10 with image data 12 for a borehole.

At 604, the method 600 includes providing, using a machine learning model, a predicted quality classification for an image in the image data at a measured depth within the borehole. In some implementations, the image quality classification tool 102 uses a machine learning model 110 in providing a predicted quality classification 16 for an image 22 in the image data 12 at a measured depth 14.

In some implementations, the machine learning model 110 is a pre-trained deep learning model that uses a convolutional neural network for providing quality classifications of images fine-tuned during training with geological images. For example, the machine learning model 110 is pre-trained using the machine learning model training workflow 200. In some implementations, the machine learning model 110 is trained using training data (e.g., the training images 30) generated from interpreted image logs 24 from different wells with quality labels added to images at different measured depths of the wells. In some implementations, the training data (e.g., the training images 30) is generated using a zonation log 28 identifying a well name, the measured depths, and the quality labels.

At 606, the method 600 includes generating a quality zone log for the image data with the predicted quality classification for the image at the measured depth. In some implementations, the image quality classification tool 102 generates a quality zone log 20 for the image data 12 with the predicted quality classification 16 for the image 22 at the measured depth 14. In some implementations, the predicted quality classification 16 includes three categories of ratings that describe an appearance of the image 22. Example categories include “poor,” “good,” and “fair.”

In some implementations, the quality zone log 20 includes a different predicted quality classification 16 of the image 22 at different measured depths 14 within the borehole. In some implementations, the quality zone log 20 includes a same predicted quality classification 16 of the image 22 at different measured depths 14 within the borehole.

At 608, the method 600 includes providing the quality zone log for presentation on a display. In some implementations, the image quality classification tool 102 provides the quality zone log 20 for presentation on a display 108. In some implementations, the method 600 includes analyzing the image for a fracture in the reservoir captured in the image at the measured depth in response to the quality classification indicating a rating of a good quality. For example, a user 104 analyzes the image 22 for a fracture in the reservoir captured in the image 22 in response to the quality classification indicating a rating of a good quality. Another example includes an application analyzing the image 22 for a fracture in the reservoir captured in the image 22 in response to the quality classification indicating a rating of a good quality.

In some implementations, the method 600 includes skipping analysis of the image 22 in response to determining the predicted quality classification 16 is a rating indicating a poor quality. For example, the user 104 skips analyzing the image 22 in response to determining the predicted quality classification 16 is a rating indicating a poor quality.

In some implementations, the method 600 includes performing an action in response to identifying the fracture captured in the image. One example action is modifying a drilling trajectory in the borehole in response to identifying the fracture captured in the image 22. For example, the drilling trajectory moves towards the identified fracture. Another example includes the drilling trajectory moves away from the identified fracture.

The method 600 automates borehole image analysis enabling quicker, more consistent, and reliable quality assessments of the borehole images. The method 600 minimizes human error, enhancing the productivity and efficiency of the borehole image interpretation, reducing operational costs and improving drilling decision making in a reservoir.

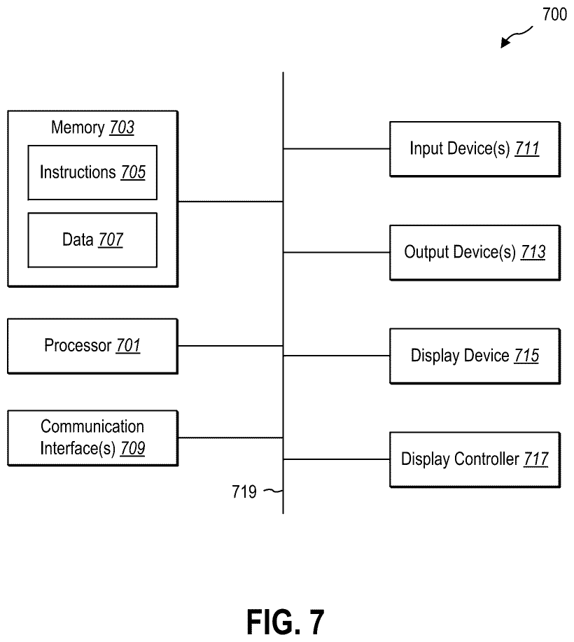

FIG. 7 illustrates components that may be included within a computer system 700. One or more computer systems 700 may be used to implement the various methods, devices, components, and/or systems described herein.

The computer system 700 includes a processor 701. The processor 701 may be a general-purpose single or multi-chip microprocessor (e.g., an Advanced RISC (Reduced Instruction Set Computer) Machine (ARM)), a special purpose microprocessor (e.g., a digital signal processor (DSP)), a graphics processing unit (GPU), a microcontroller, a programmable gate array, etc. The processor 701 may be referred to as a central processing unit (CPU). Although just a single processor 701 is shown in the computer system 700 of FIG. 7, in an alternative configuration, a combination of processors (e.g., an ARM and DSP) could be used.

The computer system 700 also includes memory 703 in electronic communication with the processor 701. The memory 703 may be any electronic component capable of storing electronic information. For example, the memory 703 may be embodied as random-access memory (RAM), read-only memory (ROM), magnetic disk storage mediums, optical storage mediums, flash memory devices in RAM, on-board memory included with the processor, erasable programmable read-only memory (EPROM), electrically erasable programmable read-only memory (EEPROM) memory, registers, and so forth, including combinations thereof.

Instructions 705 and data 707 may be stored in the memory 703. The instructions 705 may be executable by the processor 701 to implement some or all of the functionality disclosed herein. Executing the instructions 705 may involve the use of the data 707 that is stored in the memory 703. Any of the various examples of modules and components described herein may be implemented, partially or wholly, as instructions 705 stored in memory 703 and executed by the processor 701. Any of the various examples of data described herein may be among the data 707 that is stored in memory 703 and used during execution of the instructions 705 by the processor 701.

A computer system 700 may also include one or more communication interfaces 709 for communicating with other electronic devices. The communication interface(s) 709 may be based on wired communication technology, wireless communication technology, or both. Some examples of communication interfaces 709 include a Universal Serial Bus (USB), an Ethernet adapter, a wireless adapter that operates in accordance with an Institute of Electrical and Electronics Engineers (IEEE) 802.11 wireless communication protocol, a Bluetooth®wireless communication adapter, and an infrared (IR) communication port.

A computer system 700 may also include one or more input devices 711 and one or more output devices 713. Some examples of input devices 711 include a keyboard, mouse, microphone, remote control device, button, joystick, trackball, touchpad, and light pen. Some examples of output devices 713 include a speaker and a printer. One specific type of output device that is typically included in a computer system 700 is a display device 715. Display devices 715 used with embodiments disclosed herein may utilize any suitable image projection technology, such as liquid crystal display (LCD), light-emitting diode (LED), gas plasma, electroluminescence, or the like. A display controller 717 may also be provided, for converting data 707 stored in the memory 703 into text, graphics, and/or moving images (as appropriate) shown on the display device 715.

The various components of the computer system 700 may be coupled together by one or more buses, which may include a power bus, a control signal bus, a status signal bus, a data bus, etc. For the sake of clarity, the various buses are illustrated in FIG. 7 as a bus system 719.

In some implementations, the various components of the computer system 700 are implemented as one device. For example, the various components of the computer system 700 are implemented in a mobile phone or tablet. Another example includes the various components of the computer system 700 implemented in a personal computer. Another example includes the various components of the computer system 700 implemented in the cloud. Another example includes the various components of the computer system 700 implemented on an edge device.

As illustrated in the foregoing discussion, the present disclosure utilizes a variety of terms to describe features and advantages of the systems and methods. Additional detail is now provided regarding the meaning of such terms. For example, as used herein, a “machine learning model” refers to a computer algorithm or model (e.g., a classification model, a clustering model, a regression model, a language model, an object detection model, a probabilistic graphical model) that can be tuned (e.g., trained) based on training input to approximate unknown functions. For example, a machine learning model may refer to a neural network (e.g., a convolutional neural network (CNN), deep neural network (DNN), recurrent neural network (RNN), generative adversarial networks (GANs)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, implementations of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, a datastore, or another data structure), ascertaining, and the like. Also, “determining” can include receiving (e.g., receiving information), accessing (e.g., accessing data in a memory), and the like. Also, “determining” can include resolving, selecting, choosing, establishing, predicting, inferring, and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses, are intended to cover the structures described herein as performing the recited function, including both structural equivalents that operate in the same manner, and equivalent structures that provide the same function. There is no intention to invoke means-plus-function or other functional claiming for any claim except for those in which the words ‘means for’ appear together with an associated function. Each addition, deletion, and modification to the implementations that falls within the meaning and scope of the claims is to be embraced by the claims.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method comprising:
receiving an image log with image data for a borehole;
providing, using a machine learning model, a predicted quality classification for an image in the image data at a measured depth within the borehole;
generating a quality zone log for the image data with the predicted quality classification for the image at the measured depth; and
providing the quality zone log for presentation on a display.

2. The method of claim 1, wherein the machine learning model is a pre-trained deep learning model that uses a convolutional neural network for providing quality classifications of images fine-tuned during training with geological images.

3. The method of claim 1, wherein the machine learning model is trained using training data generated from interpreted image logs from different wells with quality labels added to images at different measured depths of the wells.

4. The method of claim 3, wherein the training data is generated using a zonation log identifying a well name, the different measured depths, and the quality labels.

5. The method of claim 1, wherein the quality zone log includes a different predicted quality classification of the image at different measured depths within the borehole.

6. The method of claim 1, wherein the quality zone log includes a same predicted quality classification of the image at different measured depths within the borehole.

7. The method of claim 1, wherein the predicted quality classification includes three categories of ratings that describe an appearance of the image.

8. The method of claim 1, further comprising:
analyzing the image for a fracture in a reservoir captured in the image in response to the predicted quality classification indicating a rating of a good quality.

9. The method of claim 8, further comprising:
performing an action in response to identifying the fracture captured in the image, wherein the action includes modifying a drilling trajectory in the borehole.

10. The method of claim 1, further comprising:
skipping analysis of the image in response to determining the predicted quality classification is a rating indicating a poor quality.

11. A device, comprising:
a memory to store data and instructions; and
a processor operable to communicate with the memory, wherein the processor is operable to:
receive an image log with image data for a borehole;
provide, using a machine learning model, a predicted quality classification for an image in the image data at a measured depth within the borehole;
generate a quality zone log for the image data with the predicted quality classification for the image at the measured depth; and
provide the quality zone log for presentation on a display.

12. The device of claim 11, wherein the machine learning model is a pre-trained deep learning model that uses a convolutional neural network for providing quality classifications of images fine-tuned during training with geological images.

13. The device of claim 11, wherein the machine learning model is trained using training data generated from interpreted image logs from different wells with quality labels added to images at different measured depths of the wells.

14. The device of claim 13, wherein the training data is generated using a zonation log identifying a well name, the different measured depths, and the quality labels.

15. The device of claim 11, wherein the quality zone log includes a different predicted quality classification of the image at different measured depths within the borehole.

16. The device of claim 11, wherein the quality zone log includes a same predicted quality classification of the image at different measured depths within the borehole.

17. The device of claim 11, wherein the predicted quality classification includes three categories of ratings that describe an appearance of the image.

18. The device of claim 11, wherein the processor is further operable to analyze the image for a fracture in a reservoir captured in the image in response to the predicted quality classification indicating a rating of a good quality.

19. The device of claim 18, wherein the processor is further operable to perform an action in response to identifying the fracture captured in the image, wherein the action includes modifying a drilling trajectory in the borehole.

20. The device of claim 11, wherein the processor is further operable to skip analysis of the image in response to determining the predicted quality classification is a rating indicating a poor quality.
